(19) United States
(12) Patent Application Publication
(10) Pub. No.: US 2017/0142056 A1
(43) Pub. Date: May 18, 2017

(54) METHOD AND ELECTRONIC DEVICES FOR PROCESSING EMAILS

(71) Applicant: YANDEX EUROPE AG, Luzern (CH)

(72) Inventors: Egor Vladimirovitch GANIN, Podolsky district (RU); Andrei Igorevich SUNDIEV, Moscow (RU)

(21) Appl. No.: 15/340,060

(22) Filed: Nov. 1, 2016

(30) Foreign Application Priority Data
Nov. 16, 2015 (RU) 2015149040

(51) Int. Cl. H04L 12/58; H04L 29/06

(52) U.S. Cl. CPC H04L 51/22; H04L 51/16; H04L 51/08; H04L 67/42

(57) ABSTRACT

A method of processing emails, the method being executed by an electronic device, the method comprising: retrieving, by the electronic device, a first email originated from a user of an email service and a second email destined to the user of the email service, the first email and the second email comprising a respective first and a second email-inherent data, the first and the second email-inherent data being structured according to an email-native protocol of the email service; identifying, by the electronic device, a first summary data of the first email and a second summary data of the second email; generating, by the electronic device, a first and a second message element, the first message element comprising the first summary data and the second message element comprising the second summary data for a display concurrently, the first message element being visually distinguishable from the second message element.

### CROSS-REFERENCE

The present application claims priority to Russian Patent Application No. 2015149040, filed Nov. 16, 2015, entitled “METHOD AND ELECTRONIC DEVICES FOR PROCESSING EMAILS”, the entirety of which is incorporated herein by reference.

### FIELD

The present technology relates to email display and, more specifically, to email processing.

### BACKGROUND

Electronic mail messages, usually shortened as ‘email’ or ‘e-mail’ or “email-message”, have become a very common means of communication. Indeed, in many situations, email messaging has replaced the standard post letter, the telephone and the facsimile as the preferred means of communication.

However, emails have some drawbacks: users have no way of knowing whether the email recipient is online at the particular moment the email was sent; if two people were emailing back and forth they may spend valuable time going through steps to read, reply and send messages. Mainly due to these drawbacks, one of the more popular innovations that resulted from this increased interest in and use of the Internet is instant messaging. Instant messaging, or IM, is a text-based tool that allows users to carry on conversations when connected to the Internet.

Generally, instant messaging allows quickly sending text messages between parties. Instant messaging programs may display text messages to users in a convivial manner and also allow users to exchange links to websites, share files by sending them directly to people on the user's contact list, and many other features. However, instant messaging has some drawbacks as well. For example, in most of the cases, an instant messaging service must be associated with a phone number of a user.

### SUMMARY

Developers of the present technology have developed embodiments of the present technology based on their appreciation that both email and instant messaging communications may offer complementary advantages, yet individually they are suffering from certain disadvantages. In other words, developers of the present technology have developed embodiments of the present technology based on their realization that implementing a hybrid form of communication between emails and instant messaging may have a positive effect on user experience during information exchange amongst a plurality of users. However, as previously alluded to, emails and instant messages are transmitted via different communicational platforms and, therefore, email and instant messaging communication systems are implemented in dissimilar manners.

It is an object of the present technology to ameliorate at least some of the inconveniences present in the prior art.

According to one aspect of the present technology, there is provided a method of processing emails, wherein the method is executed by an electronic device. the method comprises: retrieving, by the electronic device, a first email originated from a user of an email service and a second email destined to the user of the email service, wherein the first email and the second email comprise a respective first and a second email-inherent data, and wherein the first and the second email-inherent data are structured according to an email-native protocol of the email service; identifying, by the electronic device, a first summary data of the first email and a second summary data of the second email, wherein the identifying the first and the second summary data comprises extracting, by the electronic device, the first and second summary data from the respective first and the second email-inherent data based on the email-native protocol; generating, by the electronic device, a first and a second message element, wherein the first and the second message element are associated with the first and the second email respectively, and wherein the first message element comprise the first summary data and the second message element comprising the second summary data; and triggering, by the electronic device, a display of the first and the second message element concurrently, wherein the first message element is visually distinguishable from the second message element.

In some implementations of the method, the electronic device is a server hosting the email service.

In some implementations of the method, the triggering comprises transmitting, to a client device associated with the user, a trigger for causing a screen of the client device to display the first and the second message element concurrently.

In some implementations of the method, the electronic device is a client device associated with the user.

In some implementations of the method, the triggering comprises causing a screen of the client device to display the first and the second message element concurrently.

In some implementations of the method, the email-native protocol is Simple Mail Transfer Protocol.

In some implementations of the method, the extracting the first and the second summary data comprises extracting, by the electronic device, from the first and the second email-inherent data: a first and a second textual portion, respectively; a first and a second header specific data, respectively; and a first and a second body specific data, respectively.

In some implementations of the method, each of the first and the second header specific data comprises at least one of: a subject, a sender's email address, a recipient's email address and attachments.

In some implementations of the method, each of the first and the second body specific data comprises at least one of: an electronic signature, a greeting and particular phrases.

In some implementations of the method, the extracting the first and the second body specific data is executed via a regular expression analysis.

In some implementations of the method, the extracting the first and the second header specific data is executed via parsing.

In some implementations of the method, the first and the second message element are a first and a second interactive message element, respectively.

In some implementations of the method, upon the user interacting with the first interactive message element, the method further comprises triggering, by the electronic device, a display of the first email associated with the first interactive message element.

In some implementations of the method, upon the user interacting with the second interactive message element, the method further comprises triggering, by the electronic device, a display the second email associated with the second interactive message element.

According to another aspect of the present technology, there is provided a method of processing emails, wherein the method is executed in a system. The system includes: a communication network, a server hosting an email service, wherein the server is connected to the communication network, and a client device associated with a user of the email service, wherein the client device is connected to the communication network. The method comprises: retrieving, by the server, a first email originated from the user of the email service and a second email destined to the user of the email service, wherein the first email and the second email comprise a respective first and a second email-inherent data, and wherein the first and the second email-inherent data are structured according to an email-native protocol of the email service; identifying, by the server, a first summary data of the first email and a second summary data of the second email, wherein the identifying the first and the second summary data comprises extracting, by the server, the first and second summary data from the respective first and the second email-inherent data based on the email-native protocol; sending, by the server to the client device via the communication network, a signal comprising information associated with the first and the second summary data; generating, by the client device, a first and a second message element, wherein the first and the second message element are associated with the first and the second email respectively, and wherein the first message element comprises the first summary data and the second message element comprises the second summary data; and triggering, by the client device, a display of the first and the second message element concurrently, wherein the first message element is visually distinguishable from the second message element.

In some implementations of the method, prior to the sending the signal the method comprises generating, by the server, information for triggering the display of the first and the second message element, wherein the first and the second message element are associated with the first and the second email respectively, and wherein the first message element comprises the first summary data and the second message element comprises the second summary data. The method further comprises: sending, by the server to the client device via the communication network, the signal comprising the information for triggering the display of the first and the second message element; and triggering, by the client device, the display of the first and the second message element concurrently, wherein the first message element being is distinguishable from the second message element.

According to another aspect of the present technology, there is provided a server for processing emails, wherein the server is configured to: retrieve a first email originated from a user of an email service and a second email destined to the user of the email service, wherein the first email and the second email comprise a respective first and a second email-inherent data, and wherein the first and the second email-inherent data are structured according to an email-native protocol of the email service; identify a first summary data of the first email and a second summary data of the second email, wherein to identify the first and the second summary data comprises to extract the first and second summary data from the respective first and the second email-inherent data based on the email-native protocol; generate a first and a second message element, wherein the first and the second message element are associated with the first and the second email respectively, and wherein the first message element comprises the first summary data and the second message element comprises the second summary data; and trigger a display of the first and the second message element concurrently, wherein the first message element is visually distinguishable from the second message element.

In some implementations of the server, wherein the server is configured to extract the first and the second summary data comprises the server being configured to extract from the first and the second email-inherent data: a first and a second textual portion, respectively, a first and a second header specific data, respectively, and a first and a second body specific data, respectively.

In some implementations of the server, each of the first and the second header specific data comprises at least one of: a subject, a sender's email address, a recipient's email address and attachments.

In some implementations of the server, each of the first and the second body specific data comprises at least one of: an electronic signature, a greeting and particular phrases.

In some implementations of the server, the server is configured to extract the first and the second body specific data via a regular expression analysis.

In some implementations of the server, the server is configured to extract the first and the second header specific data via parsing.

In some implementations of the server, the first and the second message element are a first and a second interactive message element, respectively.

In some implementations of the server, upon the user interacting with the first interactive message element, the server is further configured to trigger a display of the first email associated with the first interactive message element.

In some implementations of the server, upon the user interacting with the second interactive message element, the server is further configured to trigger a display the second email associated with the second interactive message element.

According to another aspect of the present technology, there is provided a client device for processing emails, wherein the client device is configured to: retrieve a first email originated from a user of an email service and a second email destined to the user of the email service, wherein the first email and the second email comprise a respective first and a second email-inherent data, and wherein the first and the second email-inherent data are structured according to an email-native protocol of the email service; identify a first summary data of the first email and a second summary data of the second email, wherein to identify the first and the second summary data comprises to extract the first and second summary data from the respective first and the second email-inherent data based on the email-native protocol; generate a first and a second message element, wherein the first and the second message element are associated with the first and the second email respectively, and wherein the first message element comprises the first summary data and the second message element comprises the second summary data; and trigger a display of the first and the second message element concurrently, wherein the first message element is visually distinguishable from the second message element.

In some implementations of the client device, wherein the client device is configured to extract the first and the second summary data comprises the client device being configured to extract from the first and the second email-inherent data: a first and a second textual portion, respectively, a first and a second header specific data, respectively, and a first and a second body specific data, respectively.

In some implementations of the client device, wherein each of the first and the second header specific data comprises at least one of: a subject, a sender's email address, a recipient's email address and attachments.

In some implementations of the client device, each of the first and the second body redundant data comprises at least one of: an electronic signature, a greeting and redundant phrases.

In some implementations of the client device, the client device is configured to extract the first and the second body redundant data via a regular expression analysis

In some implementations of the client device, the client device is configured to extract the first and the second header redundant data via parsing.

In some implementations of the client device, wherein the first and the second message element are a first and a second interactive message element, respectively.

In some implementations of the client device, upon the user interacting with the first interactive message element, the client device is further configured to trigger a display of the first email associated with the first interactive message element.

In some implementations of the client device, upon the user interacting with the second interactive message element, the client device is further configured to trigger a display the second email associated with the second interactive message element.

In the context of the present specification, a “server” is a computer program that is running on appropriate hardware and is capable of receiving requests (e.g. from client devices such as communication devices associated with e-mail receivers) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” and “communication device” are synonymous and designate any electronic device or computer hardware that is capable of running software appropriate to the relevant task at hand and is capable further of communicating with a server, either directly or through a network, by means of a wired connection including without limitation a cable or optical fiber connection, or by means of a wireless connection including without limitation a cellular, WiFi or Bluetooth™ connection. Thus, some (non-limiting) examples of client devices or communication devices include personal computers (desktops, laptops, netbooks, etc.), and mobile devices such as smartphones and tablets, as well as network equipment such as routers, switches, and gateways. It should be noted that a device acting as a client device or communication device in the present context is not precluded from acting as a server to other client devices or communication devices. The use of the expressions “a client device” and “a communication device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer information storage medium” is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage medium, including two or more media components of a same type and/or two or more media components of different types.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts an implementation of a system 100 according to some embodiments of the present technology.

FIG. 2 depicts an embodiment of a first email interface 106′ displaying a first message element 210.

FIG. 3 depicts an embodiment of a second email interface 110′ displaying a first email.

FIG. 4 depicts an embodiment of a second email interface 110″ displaying a second email.

FIG. 5 depicts an embodiment of a first email interface 106″ displaying a first message element 210 and a second message element 516 concurrently, wherein the first message element 210 and a second message element 516 are visually distinguishable.

FIG. 6 depicts an embodiment of a first email interface 106′″ displaying a first email.

FIG. 7 depicts an embodiment of a first email interface 106″″ displaying a second email.

FIG. 8 is a flowchart of a method 800 being executed by an electronic device in some embodiments of the present technology.

FIG. 9 is a flowchart of a method 900 being executed by a system, which comprises a server, a communication network and a client device, in some embodiments of the present technology.

FIG. 10 depicts a first email-inherent data of a first email and a second email-inherent data of a second email as contemplates in some implementations of the present technology.

### DETAILED DESCRIPTION

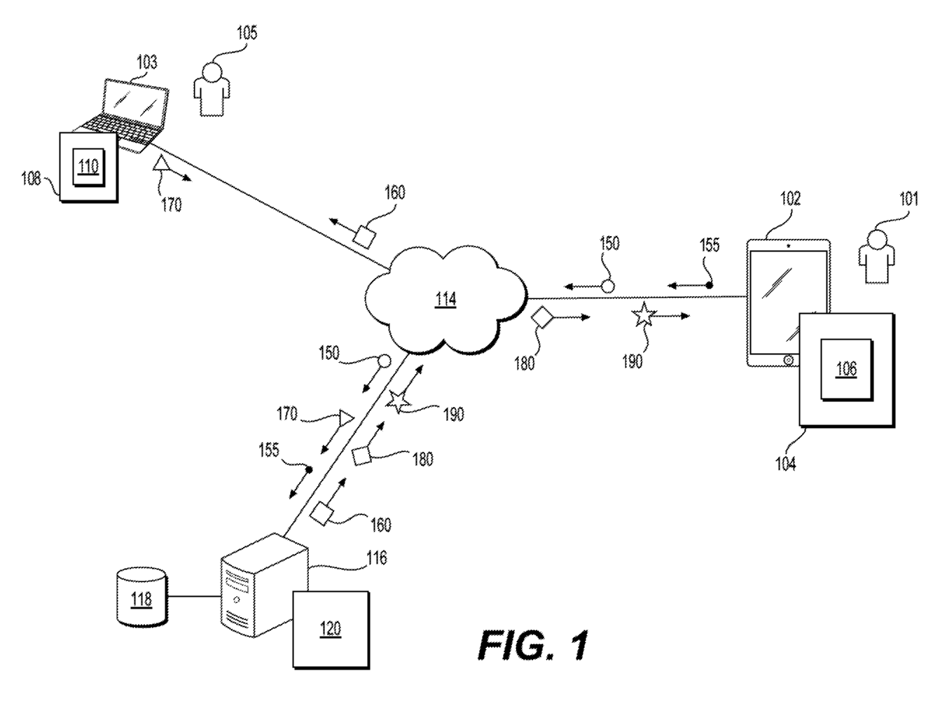

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a first client device 102. The first client device 102 is typically associated with a user 101. It should be noted that the fact that the first client device 102 is associated with the user does not need to suggest or imply any mode of operation—such as a need to log in, a need to be registered or the like.

The implementation of the first client device 102 is not particularly limited, but as an example, the first client device 102 may be implemented as a personal computer (desktops, laptops, netbooks, etc.), a wireless client device (a cell phone, a smartphone, a tablet and the like), as well as network equipment (a router, a switch, or a gateway). The general implementation of the first client device 102 is known in the art and, as such, will not be described here at much length. Suffice it to say that the first client device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communication network 114; a storage (not depicted); and a processor coupled to the user input interface, the user output interface, the network communication interface and the storage, the processor being configured to execute various routines, including those described herein below. To that end the processor may store or have access to computer readable commands which commands, when executed, cause the processor to execute the various routines described herein.

The first client device 102 comprises hardware and/or software and/or firmware (or a combination thereof), as is known in the art, to execute a first email application 104. Generally speaking, the purpose of the first email application 104 is to enable the user 101 to: browse a list of emails (both unread and read), read specific email messages, open attachments, compose new email messages, reply to email messages, forward email messages, delete email messages, manage junk email messages, assign categories to email messages, organize email messages into folders, create and access an address book, manage email display based on user preferences and the like.

In some embodiments, the first email application 104 can be implemented as a webmail interface. In other embodiments, the first email application 104 may be executed on the first client device 102 in a form of an “app”. The latter is particularly applicable but not limited to those embodiments, where the first client device 102 is implemented as a smartphone or a tablet device. Irrespective of how the first email application 104 is implemented, the first email application 104 provides the user 101 with a first email interface 106. The first email interface 106 is configured, as known in the art, to allow the user 101 to interact with the first email application 104 in order to: browse a list of emails (both unread and read), read specific email messages, open attachments, compose new e-mail messages, reply to email messages, forward email messages, delete email messages, manage junk email messages, assign categories to email messages, organize email messages into folders, create and access an address book and the like. The list of example actions that the user 101 is able to execute with the first email interface 106 is not exhaustive and may include a number of additional or different examples.

The first client device 102 may be coupled to the above-mentioned communication network 114. In some non-limiting embodiments of the present technology, the communication network 114 can be implemented as the Internet. In other embodiments of the present technology, the communication network 114 can be implemented differently, such as any wide-area communication network, local-area communication network, a private communication network and the like.

It should be expressly understood that implementations for the first client device 102 are provided for illustration purposes only. As such, those skilled in the art will easily appreciate other specific implementational details for the first client device 102. As such, by no means, examples provided herein above are meant to limit the scope of the present technology.

The system 100 may comprise a second client device 103. The second client device 103 is typically associated with a user 105. It should be noted that the fact that the second client device 103 is associated with the user 105 does not need to suggest or imply any mode of operation—such as a need to log in, a need to be registered or the like.

In some embodiments of the present technology, the second client device 103 may be implemented similarly to the first client device 102 or, as in other embodiments, in a different manner. The second client device 103 may be configured to execute a second email application 108. The second email application 108 may provide a second email interface 110. The email interface 110 may be configured, as known in the art, to allow the user 105 to interact with the second email application 108 in order to: browse a list of emails (both unread and read), read specific email messages, open attachments, compose new email messages, reply to email messages, forward email messages, delete email messages, manage junk email messages, assign categories to email messages, organize email messages into folders, create and access an address book and the like. The list of example actions that the user 105 is able to execute with the second email interface 110 is not exhaustive and may include a number of additional or different examples. It should be noted that the second email application 108 may be distinct or identical to the first email application 104.

In other embodiments of the present technology, the system 100 may comprise a server 116. The server 116 may be implemented as a conventional computer server. In an example of an embodiment of the present technology, the server 116 may be implemented as a Dell™ PowerEdge™ Server running the Microsoft™ Windows Server™ operating system. Needless to say, the server 116 may be implemented in any other suitable hardware and/or software and/or firmware or a combination thereof. In the depicted non-limiting embodiment of present technology, the server 116 is a single server. In alternative non-limiting embodiments of the present technology, the functionality of the server 116 may be distributed and may be implemented via multiple servers.

The implementation of the server 116 is well known. However, briefly speaking, the server 116 may comprise a communication interface (not depicted) structured and configured to communicate with various entities (such as the first and second client devices 102 and 103, for example and other devices potentially coupled to the communication network 114) via the communication network 114. The server 116 may further comprises at least one computer processor (not depicted) operationally connected with the communication interface and structured and configured to execute various processes to be described herein.

In some embodiments, the server 116 may be operated by the same entity that has provided the afore-described first email application 104. In alternative embodiments, the server 116 may be operated by an entity different from the one who has provided the afore-mentioned first mail application 104. The server 116 may implement an email service such as Yandex.Mail, for example. It should be noted, the server 116 may implement any other email service.

In some embodiments of the present technology, the server 116 may comprise a processing module 120. The processing module 120 may be configured to execute at least some routines to be described herein. The server 116 may be operatively connected to a database 118. In some embodiments of the present technology, the database 118 may be configured to store information related to emails which are destined to and/or originating from the user 101, the user 105 and other potential users of the email service implemented by the server 116. It should be noted that, in some implementations of the present technology, the processing module 120, the server 116 and the database 118 may be implemented as part of a single entity. In other words, the functionalities of the processing module 120, the server 116 and the database 118 may be executed by the server 116 as the single entity.

In additional embodiments, the database 118 may store account information associated with the user 101, the user 105 and the other potential users of the email service implemented by the server 116. For example, the database 118 may store a first account information associated with the user 101, a second account information associated with the user 105, and other potential account information respectively associated to each one of the other potential users of the email service.

In other embodiments, the server 116 may be configured to store within the database 118 information received and/or sent thereby. For example, the server 116 may store the information received and/or sent by the server 116 via a first signal 150, a second signal 155, a third signal 180, a fourth signal 160, a fifth signal 170 and a sixth signal 190.

SCENARIO 1: Processing by the Server

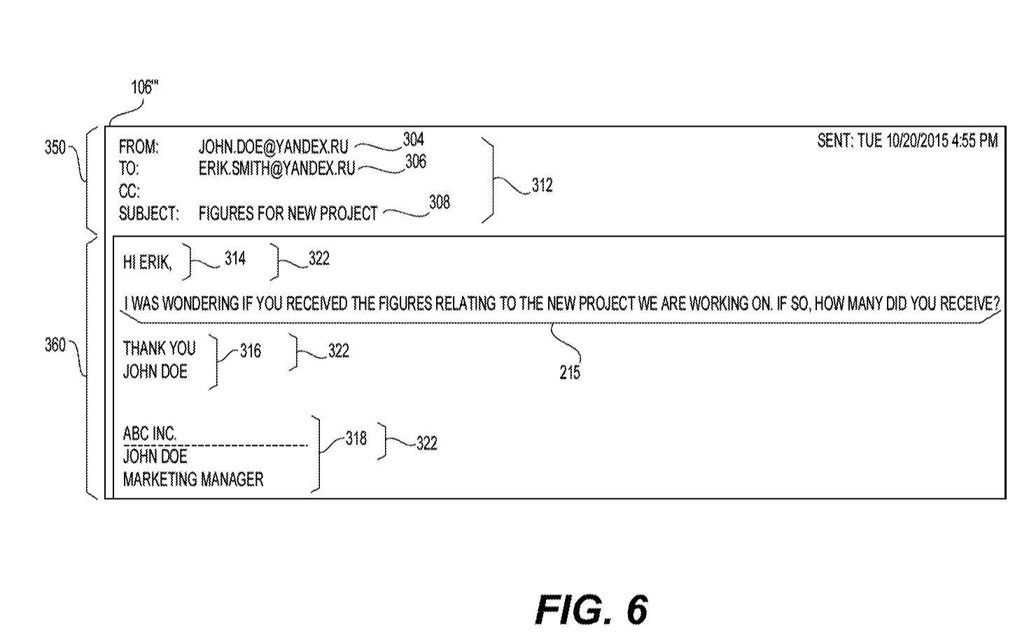

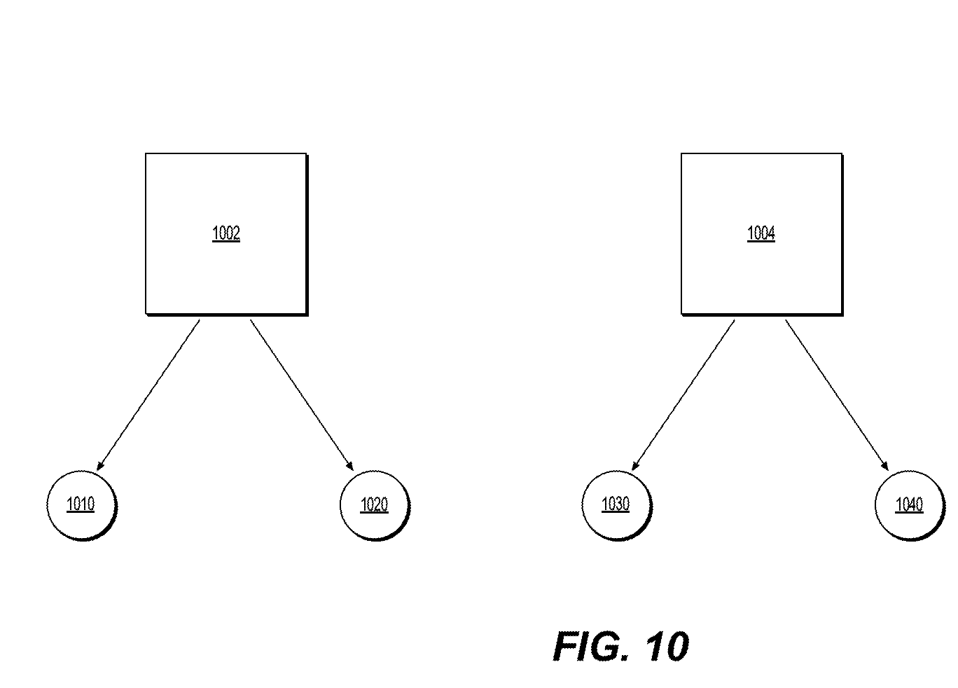

With reference to FIG. 6, there is depicted an embodiment of the first email interface 106′″. The first email interface 106′″ may display a first email. Let's assume that the first email has been sent from a first email address associated with the user 101 to a second email address associated with the user 105 (see FIG. 1). In some embodiments of the present technology, the first email may comprise a first email-inherent data 1002, depicted in FIG. 10, which is structured according to the email-native protocol implemented by the server 116. In other words, the first email-inherent data may correspond to information which enables transmission and display of the first email. For example, the first client device 102 may have generated the first signal 150 which comprises information associated with the first email-inherent data and may have sent the first signal 150 to the server 116 via the communication network 114.

As previously alluded to, the server 116 may store the information received via the first signal 150 within the database 118. In some embodiments of the present technology, as depicted in FIG. 6, the first email may comprise a first header 350 and a first body 360. The first header 350 may comprise a sender's email address 304, a recipient's email address 306 and a subject 308. The first body 360 may comprise a greeting 314, a first textual portion 215, a first particular phrase 316, and an electronic signature 318. The first email-inherent data 1002 may comprise a first header data 1010 associated with the first header 350 and a first body data 1020 associated with the first body 360 (see FIG. 10). It should be noted that the first email-inherent data 1002 may also comprise additional data and that the first email may comprise additional elements. In other words, the sender's email address 304, the recipient's email address 306, the subject 308, the greeting 314, the first textual portion 215, the first particular phrase 316, and the electronic signature 318 are examples of elements only and are depicted in FIG. 6 for ease of understanding only.

In this case, the sender's email address 304 is john.doe@yandex.ru, which is the first email address associated with the user 101, and the recipient's email address 306 is erik.smith@yandex.ru, which is the second email address associated with the user 105. Further, the subject 308 is “Figures for new project” and may be assigned by the user 101 as known in the art.

In other embodiments of the present technology, the user 101 may be desirous of viewing emails originated from and/or destined to the user 101 in a messenger-style display. For example, the email application 104 executed by the first client device 102 may receive a display indication (not depicted) from the user 101 to display the emails originated from and/or destined to the user 101 in the messenger-style display. In response to the display indication, the first client device 102 may generate and send the second signal 155, via the communication network 114, to the server 116.

Upon receiving the second signal 155, the server 116 may be configured to retrieve the first email-inherent data 1002 of the first email from the database 118 and transmit the first email-inherent data 1002 to the processing module 120 for processing thereof.

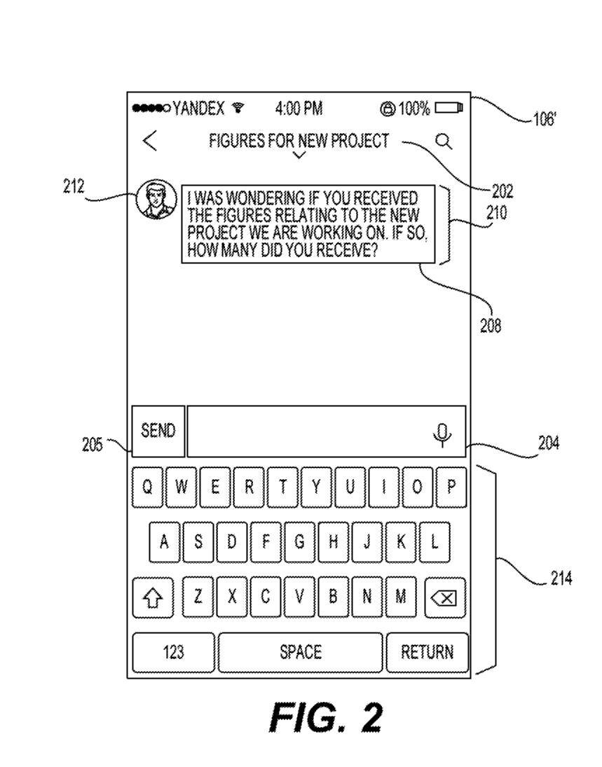

In some embodiments, the processing module 120 may be configured to identify a first summary data 210 (depicted in FIG. 2) of the first email. In order to identify the first summary data 210, the processing module 120 of the server 116 may be configured to extract the first summary data 210 from the first email-inherent data 1002 based on the email-native protocol. In other embodiments, the processing module 120 may be configured to extract the first textual portion 215, a first header specific data 312 and a first body specific data 322 from the first email-inherent data 1002 (see FIG. 6).

In some embodiments, the processing module 120 may extract the first header specific data 312 from the first header data 1010 (see FIG. 10) associated with the first header 350. For example, the processing module 120 may extract the first header specific data 312 which comprises the sender's email address 304, the recipient's email address 306 and the subject 308. The processing module 120 may extract the first header specific data 312 from the first header data 1010 by applying a mask. Also, the processing module 120 may extract the first header specific data 312 from the first header data 1010 via parsing. For instance, the processing module 120 may apply string parsing based on the mask on the first header data 1010 of the first email-inherent data 1002.

In other embodiments, the processing module 120 may extract the first body specific data 322 from the first header data 1010 associated with the first body 360. For example, the processing module 120 may extract the first body specific data 322 which comprises the greeting 314, the first particular phrase 316 and the electronic signature 318. The processing module 120 may extract the first body specific data 322 from the first body data 1020 (see FIG. 10) by executing a regular expression analysis.

The processing module 120 may extract the greeting 314. For example, the processing module 120 may determine that the first body 360 comprises a first line “Hi Erik,”. Further, the processing module 120 may determine that the first line of the first body 360 comprising a generic greeting word “Hi” and a user name “Erik” is a greeting line and, therefore, may extract the greeting 314 from the first email-inherent data 1002. It should be noted that in other implementations of the present technology, the greeting line may also comprise other generic greeting words and/or expressions such as “Hi”, “Hello”, “Good morning”, “Hey” and the like as well as other user names.

The processing module 120 may extract the first particular phrase 316. For example, the processing module 120 may determine that the first body 360 comprises a phrase “Thank you, John Doe”. Further, the processing module 120 may determine that the phrase of the first body 360 comprising a farewell expression “Thank you” and another user name “John Doe” is a farewell phrase and, therefore, may extract the first particular phrase 316. It should be noted that in other implementations of the present technology, the first particular phrase 316 may also comprise generic farewell words and/or expressions such as “Thanks”, “Have a nice day”, “Bye”, “Yours truly” and the like as well as other user names.

The processing module 120 may extract the electronic signature 318. For example, the processing module 120 may determine that the first body 360 comprises a certain object, a certain image or a certain phrase. Based on the email-inherent data associated with the certain object, the certain image or the certain phrase, the processing module 120 may extract the electronic signature 318.

The processing module 120 may extract the summary data 210. For example, the summary data 210 may correspond to the textual portion 215 of the first body 360 that is not determined to be a part of the first body specific data 322. In another instance, the processing module 120 may extract the summary data 210 by extracting the textual portion 215 between the greeting 314 and the first particular phrase 316. It should be noted that the server 116 may store information associated with the first header specific data 312, the first body specific data 322 and the first summary data 210 within the database 118.

In additional embodiments of the present technology, the server 116 may be configured to generate a first message element 208 depicted in FIG. 2. In other words, the server 116 may generate information for displaying the first message element 208. The first message element 208 may be associated with the first email and may comprise the first summary data 210 of the first email.

In other embodiments of the present technology, the server 116 may trigger a display of the first message element 208 to the user 101 desirous to view the emails originated from and/or destined to the user 101 in the messenger-style display. To that end, the server 116 may generate and send the third signal 180 to the first client device 102 via the communication network 114 (see FIG. 1).

In some embodiments, the third signal 180 may comprise inter alia information for triggering the display of the first message element 208 to the user 101. In other embodiments, the third signal 180 may further comprise the first email-inherent data 1002 of the first email, wherein the first email-inherent data 1002 is structured according to the email-native protocol of the email service implemented by the server 116 (see FIG. 10). In another embodiment, the third signal 180 may comprise information associated with the first header specific data 312, the first body specific data 322 and the first textual portion 215.

With reference to FIG. 2, there is depicted an embodiment of the first email interface 106′. The first email interface 106′ may comprise a conversation title 202, a text field 204, a send button 205 and a first user icon 212 associated with the user 101. In some embodiments, the information within the third signal 180 may trigger the first email application 104 to display the first email interface 106′. The information within the third signal 180 may assign the subject 308 of the first email as the conversation title 202. The information within the third signal 180 may trigger the display of the first message element 208, which comprises the first summary data 210 of the first email.

In other embodiments, the information within the third signal 180 may trigger the display of the first email in the messenger-style display as depicted in FIG. 2. In other words, the first email interface 106′ may display to the user 101 the messenger-style display of the first email within the first email application 104.

In different embodiments of the present technology, the server 116 may be configured to generate the fourth signal 160. The fourth signal 160 may comprise inter alia information associated with the first email-inherent data 1002 of a first email, wherein the first email-inherent data 1002 is structured according to the email-native protocol of the email service implemented by the server 116. The server 116 may be configured to send the fourth signal 160, via the communication network 114, to the second client device 103.

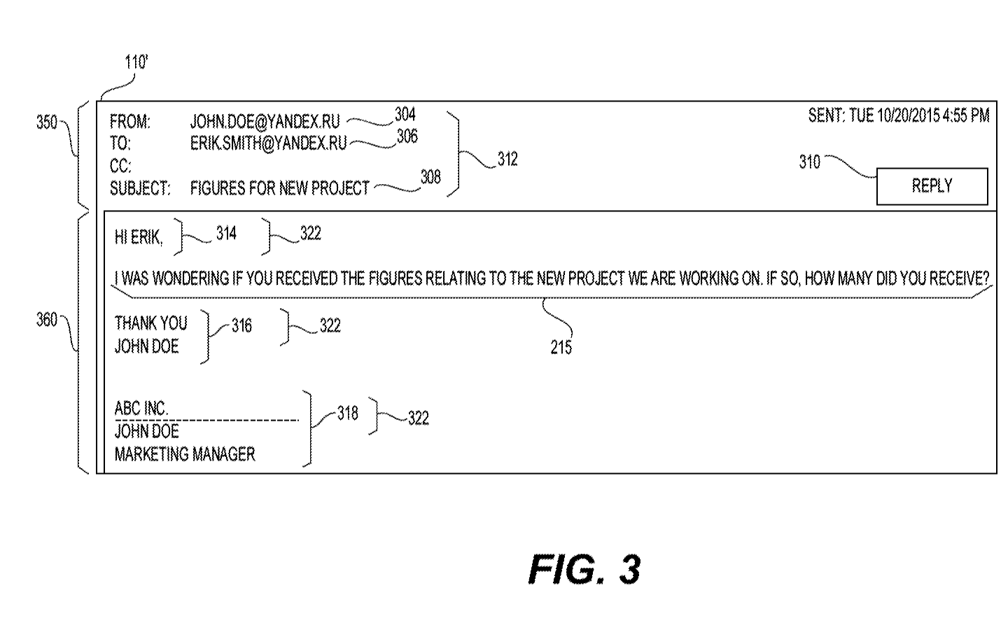

With reference to FIG. 3, there is depicted an embodiment of the second email interface 110′ of the second email application 108 displayed to the user 105 of the second client device 103. As previously mentioned, the second email interface 110′ may display the first email comprising the first header 350 and the first body 360. The first header 350 may comprise the sender's email address 304, the recipient's email address 306, the subject 308 and a reply button 310. The reply button 310 may be generated by the second email application 108 and displayed within the first header 350. The first body 360 may comprise the greeting 314, the first textual portion 215, the first particular phrase 316, and the electronic signature 318. The first email-inherent data 1002 may comprise the first header data 1010 associated with the first header 350 and the first body data 1020 associated with the first body 360.

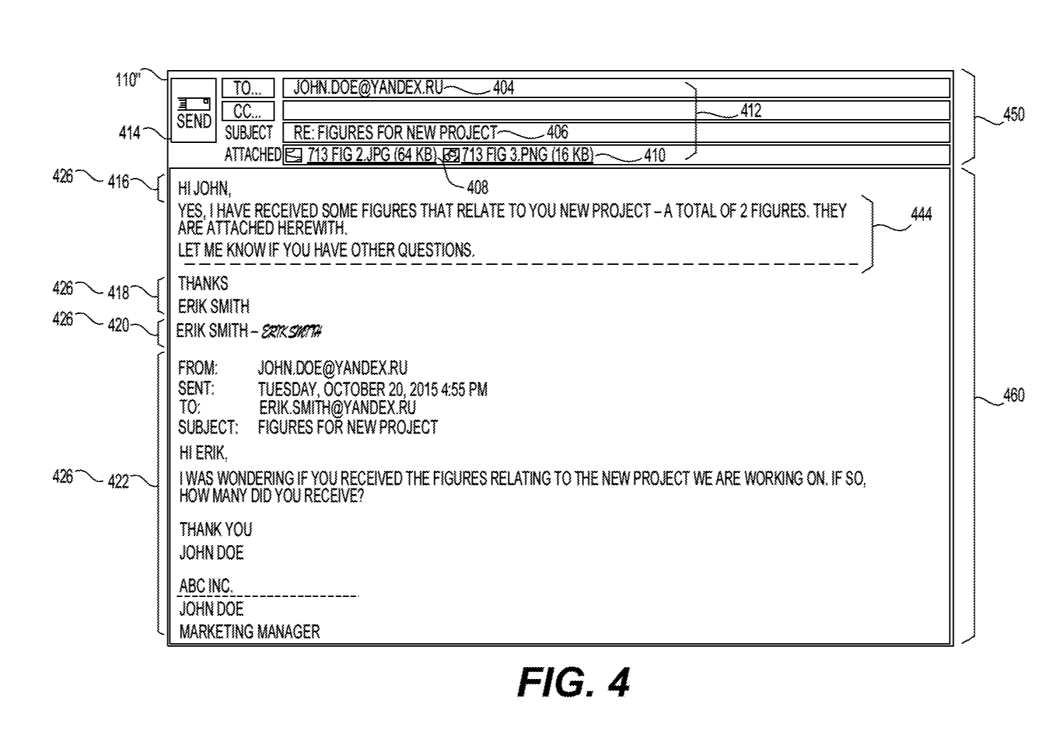

In additional embodiments of the present technology, the user 105 may select/interact with the reply button 310 to send a second email destined to the user 101. With reference to FIG. 4, there is depicted another embodiment of the second email interface 110″ of the second email application 108 executed by the second client device 103.

In some embodiments of the present technology, the second email may comprise a second header 450 and a second body 460. The second header 450 may comprise a recipient's email address 404, a subject 406, a first attachment indication 408 of a first attachment and a second attachment indication 410 of a second attachment. The second body 460 may comprise a greeting 416, a second textual portion 444, a second particular phrase 418, phrases 422 and an electronic signature 420. The second email may comprise a second email-inherent data 1004 depicted in FIG. 10. The second email-inherent data 1004 may comprise a second header data 1030 associated with the second header 450 and a second body data 1040 associated with the second body 460. The second email-inherent data 1004 may comprise the first attachment and the second attachment. The second email may also comprise a send button 414 for enabling the user 105 to send the second email. It should be noted that the second email-inherent data 1004 may also comprise additional data and that the second email may comprise additional elements. In other words, the recipient's email address 404, the subject 406, the first attachment 408, the second attachment 410, the send button 414, the greeting 416, the second textual portion 444, the second particular phrase 418, the particular phrases 422 and the electronic signature 420 are examples of elements and are displayed, as depicted in FIG. 4, for ease of understanding only.

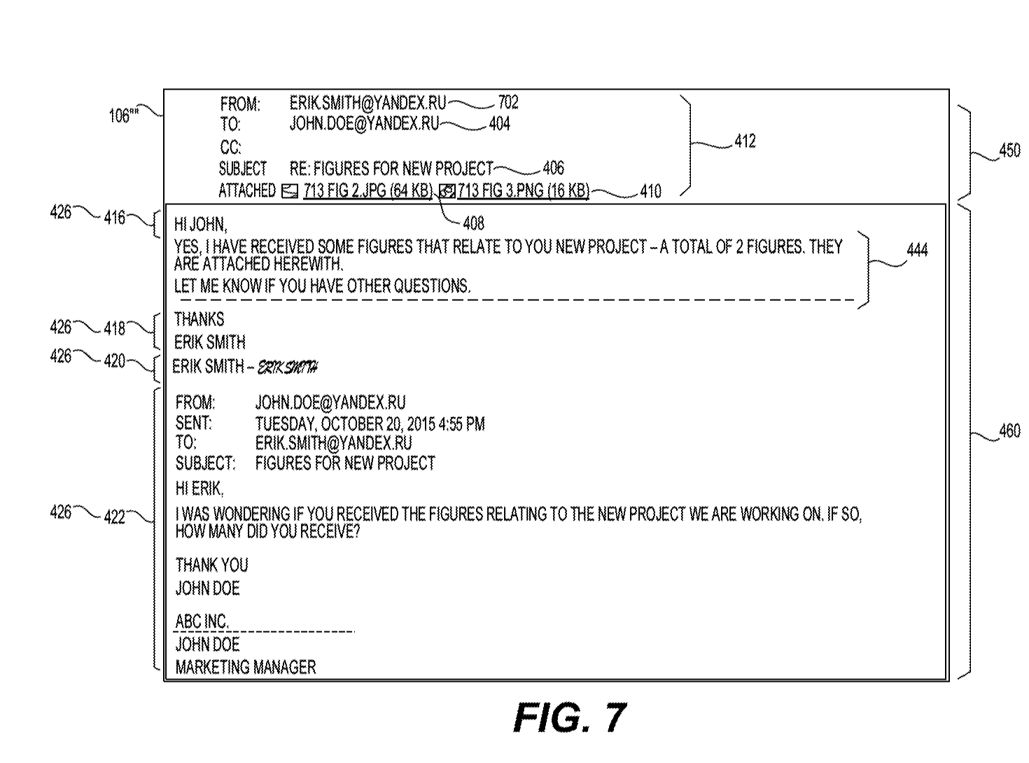

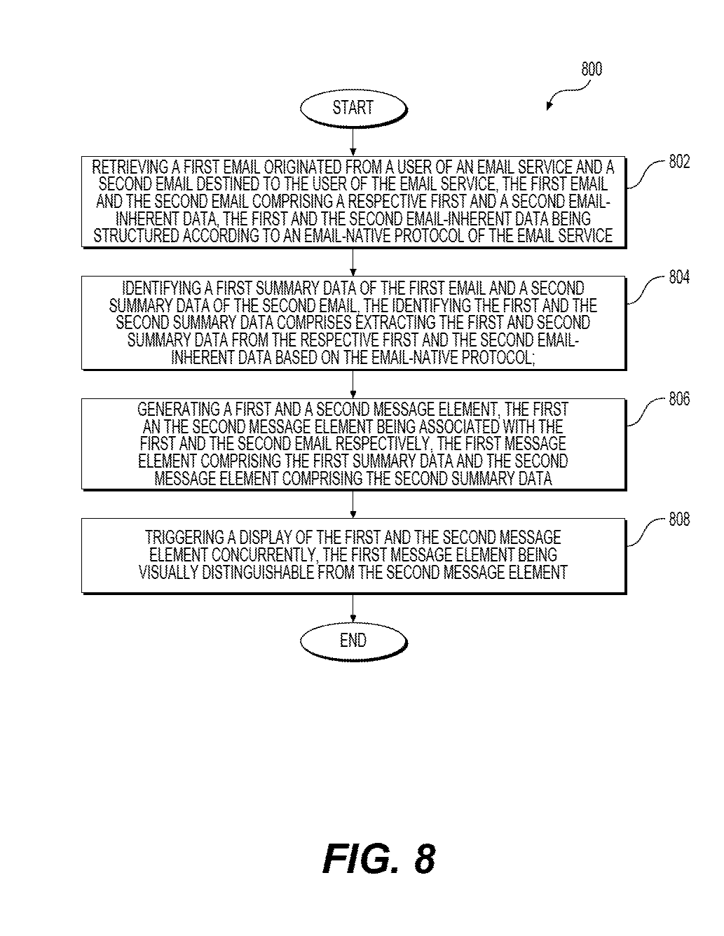

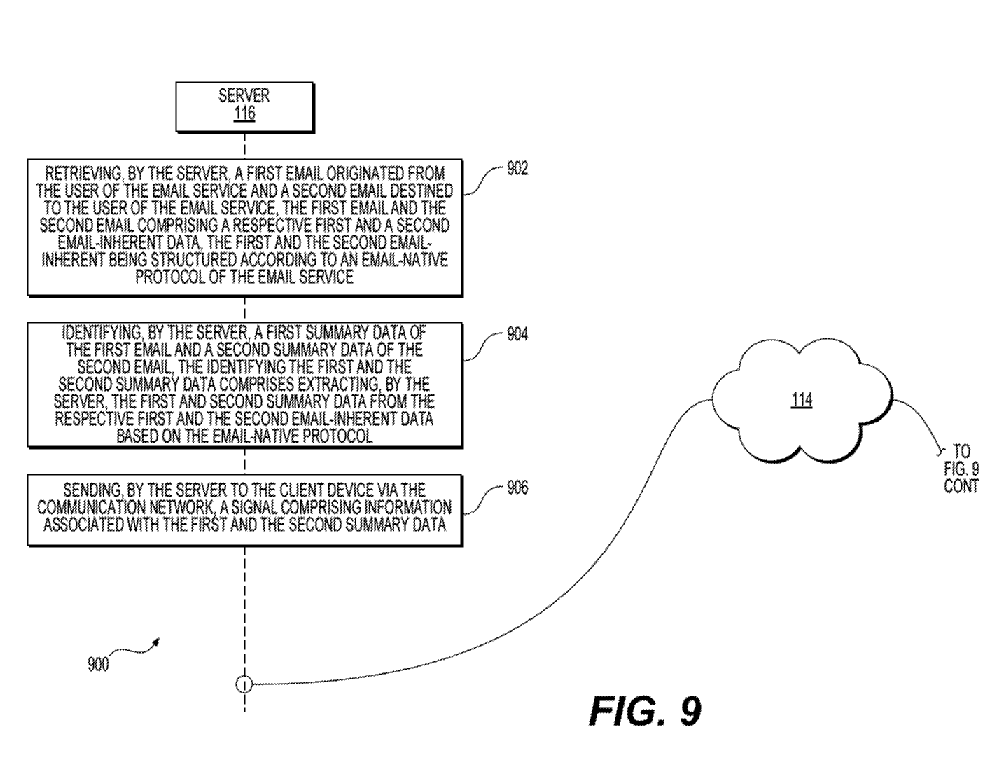

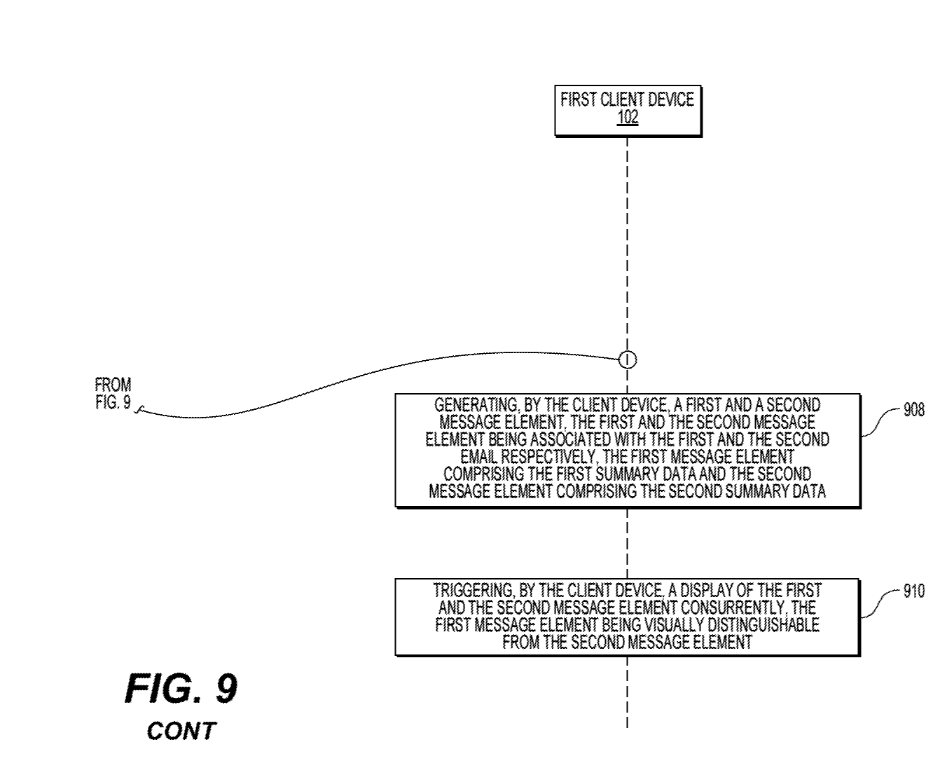

For example, the user 105 may enter the greeting 416, the second textual portion 444 and the second particular phrase 418 via a user input interface of the second client device 103. The user 105 may also attach the first attachment and the second attachment. Further, the recipient's email address 404, the subject 406, the send button 414 and the particular phrases 422 may be generated automatically by the second email application 108 and displayed to the user 105 via the second email interface 110″ as it is known in the art. It should be noted that the second header data 1030 (see FIG. 10) may also comprise information associated with the second email address since in this case the second email address is a sender's email address 702 of the second email (see FIG. 7).

In some embodiments of the present technology, the user 105 may select/interact with the send button 414. In this case, the second client device 103 may generate the fifth signal 170 (see FIG. 1) comprising inter alia information associated with the second email-inherent data 1004 of the second email, wherein the second email-inherent data 1004 is structured according to the email-native protocol of the email service implemented by the server 116 (see FIG. 10). The second client device 103 may send the fifth signal 170, via the communication network 114, to the server 116.

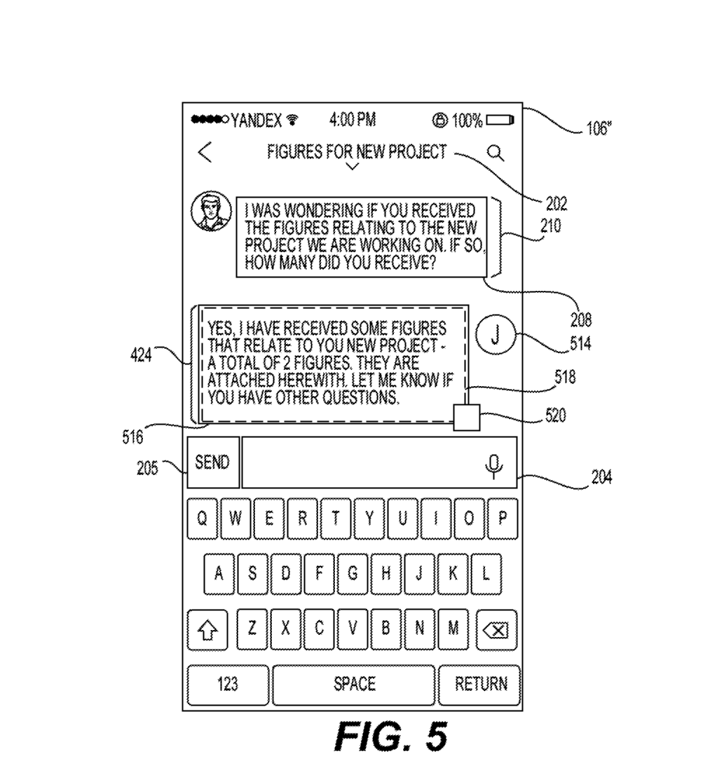

As previously alluded to, the server 116 may store the information received via the fifth signal 170 within the database 118. In other embodiments, the server 116 may be configured to send the information received via the fifth signal 170 to the processing module 120 for processing thereof. In other words, the processing module 120 may be configured to identify a second summary data 424 (see FIG. 5) within the second body data 1040 of the second email-inherent data 1004. In some embodiments, the processing module 120 may extract the second summary data 424 from the second email-inherent data 1004.

For example, in order to extract the second summary data 424, the processing module 120 may be configured to extract a second header specific data 412 within the second email-inherent data 1004, a second body specific data 426 within the second email-inherent data 1004 and the second summary data 424 (see FIG. 4). The processing module 120 may extract the second header specific data 412 from the second email-inherent data 1004 by parsing the second header data 1030 of the second email-inherent data 1004. The processing module 120 may extract the second body specific data 426 by executing a regular expression analysis. For example, the processing module 120 may execute the regular expression analysis on the second body data 1040 of the second email-inherent data 1004.

The processing module 120 may extract the first summary data 210 from the first email-inherent data 1002 and the second summary data 424 from the second email-inherent data 1004 in a similar manner. In other words, the processing module 120 may extract the first textual portion 215 from the first email-inherent data 1002 and the second textual portion 444 from the second email-inherent data 1004 in a similar manner. The processing module 120 may extract the first header specific data 312 from the first email-inherent data 1002 and the second header specific data 412 from the second email-inherent data 1004 in a similar manner. The processing module 120 may extract the first body specific data 322 from the first email-inherent data 1002 and the second body specific data 426 from the second email-inherent data 1004 in a similar manner. Further, the server 116 may store the second header specific data 412 of the second email-inherent data 1004, the second body specific data 426 of the second email-inherent data 1004 and the second summary data 424 within the database 118.

In additional embodiment of the present technology, the processing module 120 of the server 116 may generate a second message element 516 depicted in FIG. 5. In other words, the processing module 120 may generate information for displaying the second message element 516. The second message element 516 may comprise the second summary data 424 extracted from the second email-inherent data 1004 (see FIG. 10). The second message element 516 may be associated with the second email. As mentioned above, the server 116 may store the information associated with the second message element 516 within the database 118.

In some embodiments, the server 116 may be configured to trigger a display of the first message element 208 and the second message element 516 concurrently to the user 101 desirous to view the emails originated from and/or destined to the user 101 in the messenger-style display. To that end, the server 116 may be configured to generate and send the sixth signal 190 to the first client device 102 via the communication network 114.

In some embodiments, the sixth signal 190 may comprise inter alia information for triggering the display of the first message element 208 and the second message element 516 concurrently to the user 101. In other embodiments, the sixth signal 190 may further comprise the first email-inherent data 1002 of the first email, wherein the first email-inherent data 1002 is structured according to the email-native protocol of the email service implemented by the server 116. In additional embodiments, the sixth signal 190 may further comprise the second email-inherent data 1004 of the second email, wherein the second email-inherent data 1004 is structured according to the email-native protocol of the email service implemented by the server 116. In another embodiment, the sixth signal 190 may comprise information associated with the first header specific data 312, the first body specific data 322, the first textual portion 215, the second header specific data 412, the second body specific data 426 and the second textual portion 444.

Another embodiment of the first email interface 106″ is depicted in FIG. 5. In this case, the first email interface 106″ may comprise the conversation title 202, the first message element 208 with the first summary data 210, the first user icon 212, a second user icon 514, the second message element 516 with the second summary data 424, the text field 204 and the send button 205.

In other embodiments, the information within the sixth signal 190 may trigger the display of the first email and the second email in the messenger-style display as depicted in FIG. 5. In other words, the first email interface 106′ may display to the user 101 the messenger-style display of the first email and the second email within the first email application 104.

It should be noted that the first message element 208, as depicted in FIG. 5, may be visually distinguishable from the second message element 516. For example, the first user icon 212 and the second user icon 514 may allow the user 101 to visually distinguish the first message element 208 from the second message element 516 being displayed concurrently. As another example, a visual element 518 may allow the user 101 to visually distinguish the first message element 208 form the second message element 516. Also, the second message element 516 may have a different color, font, size and/or positioning from the first message element 208 for allowing the user 101 to visually distinguish the first message element 208 form the second message element 516 being displayed concurrently.

In alternative embodiments of the present technology, an attachment element 520 may be displayed as part of the second message element 516. The attachment element 520 may indicate the user 101 that the second message element 516 is associated with the second email which comprises at least one attachment (e.g., the first attachment and the second attachment).

In some embodiments of the present technology, the first message element 208 and the second message element 516 displayed to the user 101 by the first email interface 106″ depicted in FIG. 5 may be a first interactive message element and a second interactive message element, respectively.

In alternative embodiments, upon the user 101 interacting with the first interactive message element, the first client device 102 may send an indication (not depicted) of the interaction with the first interactive message element to the server 116. In response, the server 116 may be configured to trigger a display of the first email associated with the first interactive message element.

For example, an additional embodiment of the first email interface 106′″ is depicted in FIG. 6. In this case, the first email interface 106′″ may display the first email associated with the first interactive message element following the triggering of the display by the server 116.

In some embodiments, upon the user 101 interacting with the second interactive message element, the first client device 102 may send an indication (not depicted) of the interaction with the second interactive message element to the server 116. In response, the server 116 may be configured to trigger the display of the second email associated with the second interactive message element.

For example, an additional embodiment of the first email interface 106″″ is depicted in FIG. 7. In this case, the first email interface 106″″ may display the second email associated with the second interactive message element following the triggering of the display by the server 116. It should be noted, that the user 101 may open the first attachment and/or the second attachment by interacting with the first attachment indication 408 and/or the second attachment indication 410, respectively, within the first email interface 106″″.

SCENARIO 2: Processing by the Client Device

With reference to FIG. 6, there is depicted an embodiment of the first email interface 106′″. The first email interface 106′″ may display the first email. Let's assume that the first email has been sent from a first email address associated with the user 101 to the second email address associated with the user 105 (see FIG. 1). In some embodiments of the present technology, the first email may comprise the first email-inherent data 1002 being structured according to the email-native protocol implemented by the server 116 (see FIG. 10). For example, the first client device 102 may have generated the first signal 150 which comprises information associated with the first email-inherent data 1002 and may have sent the first signal 150 to the server 116 via the communication network 114. The first client device 102 may store the first email-inherent data 1002 within the storage (not depicted) thereof.

In some embodiments of the present technology, as depicted in FIG. 6, the first email may comprise the first header 350 and the first body 360. The first header 350 may comprise the sender's email address 304, the recipient's email address 306 and the subject 308. The first body 360 may comprise the greeting 314, the first textual portion 215, the first particular phrase 316, and the electronic signature 318. The first email-inherent data 1002 may comprise the first header data 1010 associated with the first header 350 and the first body data 1020 associated with the first body 360 (see FIG. 10). It should be noted that the first email-inherent data 1002 may also comprise additional data and that the first email may comprise additional elements. In other words, the sender's email address 304, the recipient's email address 306, the subject 308, the greeting 314, the first textual portion 215, the first particular phrase 316, and the electronic signature 318 are examples of elements only and are depicted in FIG. 6 for ease of understanding only.

In this case, the sender's email address 304 is john.doe@yandex.ru, which is the first email address associated with the user 101, and the recipient's email address 306 is erik.smith@yandex.ru, which is the second email address associated with the user 105. Further, the subject 308 is “Figures for new project” and may be assigned by the user 101 as known in the art.

In other embodiments of the present technology, the user 101 may be desirous of viewing emails originated from and/or destined to the user 101 in a messenger-style display. For example, the email application 104 executed by the first client device 102 may receive the display indication (not depicted) from the user 101 to display the emails originated from and/or destined to the user 101 in the messenger-style display.

Upon receiving the display indication from the user, the first client device 102 may be configured to retrieve the first email-inherent data 1002 of the first email from the storage thereof.

In some embodiments, the first client device 102 may be configured to identify the first summary data 210 (depicted in FIG. 2) of the first email. In order to identify the first summary data 210, the first client device 102 may be configured to extract the first summary data 210 from the first email-inherent data 1002 based on the email-native protocol. In other embodiments, the first client device 102 may be configured to extract the first textual portion 215, the first header specific data 312 and the first body specific data 322 from the first email-inherent data 1002 (see FIG. 6).

In some embodiments, the first client device 102 may extract the first header specific data 312 from the first header data 1010 (see FIG. 10) associated with the first header 350. For example, the first client device 102 may extract the first header specific data 312 which comprises the sender's email address 304, the recipient's email address 306 and the subject 308. The first client device 102 may extract the first header specific data 312 from the first header data 1010 by applying the mask. Also, the first client device 102 may extract the first header specific data 312 from the first header data 1010 via parsing. For instance, the first client device 102 may apply string parsing based on the mask on the first header data 1010 of the first email-inherent data 1002.

In other embodiments, the first client device 102 may extract the first body specific data 322 from the first header data 1010 (see FIG. 10) associated with the first body 360. For example, the first client device 102 may extract the first body specific data 322 which comprises the greeting 314, the first particular phrase 316 and the electronic signature 318. The first client device 102 may extract the first body specific data 322 from the first body data 1020 by executing the regular expression analysis.

The first client device 102 may extract the greeting 314. For example, the first client device 102 may determine that the first body 360 comprises the first line “Hi Erik,”. Further, the first client device 102 may determine that the first line of the first body 360 comprising the generic greeting word “Hi” and the user name “Erik” is the greeting line and, therefore, may extract the greeting 314 from the first email-inherent data 1002. It should be noted that in other implementations of the present technology, the greeting line may also comprise other generic greeting words and/or expressions such as “Hi”, “Hello”, “Good morning”, “Hey” and the like as well as other user names.

The first client device 102 may extract the first particular phrase 316. For example, the first client device 102 may determine that the first body 360 comprises the phrase “Thank you, John Doe”. Further, the first client device 102 may determine that the phrase of the first body 360 comprising the farewell expression “Thank you” and another user name “John Doe” is the farewell phrase and, therefore, may extract the first particular phrase 316. It should be noted that in other implementations of the present technology, the first particular phrase 316 may also comprise the generic farewell words and/or expressions such as “Thanks”, “Have a nice day”, “Bye”, “Yours truly” and the like as well as other user names.

The first client device 102 may extract the electronic signature 318. For example, the first client device 102 may determine that the first body 360 comprises the certain object, the certain image or the certain phrase. Based on the email-inherent data associated with the certain object, the certain image or the certain phrase, the first client device 102 may extract the electronic signature 318.

The first client device 102 may extract the summary data 210. For example, the summary data 210 may correspond to the textual portion 215 of the first body 360 that is not determined to be a part of the first body specific data 322. In another instance, the first client device 102 may extract the summary data 210 by extracting the textual portion 215 between the greeting 314 and the first particular phrase 316. It should be noted that the first client device 102 may store information associated with the first header specific data 312, the first body specific data 322 and the first summary data 210 within the storage of the first client device 102.

In additional embodiments of the present technology, the first client device 102 may be configured to generate the first message element 208 depicted in FIG. 2. In other words, the first client device 102 may generate the information for displaying the first message element 208. The first message element 208 may be associated with the first email and may comprise the first summary data 210 of the first email.

In other embodiments of the present technology, the first client device 102 may trigger the display of the first message element 208 to the user 101 desirous to view the emails originated from and/or destined to the user 101 in the messenger-style display.

With reference to FIG. 2, there is depicted an embodiment of the first email interface 106′. The first email interface 106′ may comprise the conversation title 202, the text field 204, the send button 205 and the first user icon 212 associated with the user 101. In some embodiments, the first client device 102 may trigger the first email application 104 to display the first email interface 106′. The first client device 102 may assign the subject 308 of the first email as the conversation title 202. The first client device 102 may trigger the display of the first message element 208, which comprises the first summary data 210 of the first email.

In other embodiments, the first client device 102 may trigger the display of the first email in the messenger-style display as depicted in FIG. 2. In other words, the first email interface 106′ may display to the user 101 the messenger-style display of the first email within the first email application 104.

In different embodiments of the present technology, the server 116 may be configured to generate the fourth signal 160. The fourth signal 160 may comprise inter alia information associated with the first email-inherent data 1002 of the first email, wherein the first email-inherent data 1002 is structured according to the email-native protocol of the email service implemented by the server 116 (see FIG. 10). The server 116 may be configured to send the fourth signal 160, via the communication network 114, to the second client device 103.

With reference to FIG. 3, there is depicted an embodiment of the second email interface 110′ of the second email application 108 displayed to the user 105 of the second client device 103. As previously mentioned, the second email interface 110′ may display the first email comprising the first header 350 and the first body 360. The first header 350 may comprise the sender's email address 304, the recipient's email address 306, the subject 308 and a reply button 310. The reply button 310 may be generated by the second email application 108 and displayed within the first header 350. The first body 360 may comprise the greeting 314, the first textual portion 215, the first particular phrase 316, and the electronic signature 318. The first email-inherent data 1002 may comprise the first header data 1010 associated with the first header 350 and the first body data 1020 associated with the first body 360 (see FIG. 10).

In additional embodiments of the present technology, the user 105 may select/interact with the reply button 310 to send the second email destined to the user 101. With reference to FIG. 4, there is depicted another embodiment of the second email interface 110″ of the second email application 108 executed by the second client device 103.

In some embodiments of the present technology, the second email may comprise the second header 450 and the second body 460. The second header 450 may comprise the recipient's email address 404, the subject 406, the first attachment indication 408 of the first attachment, the second attachment indication 410 of the second attachment and the send button 414. The second body 460 may comprise the greeting 416, the second textual portion 444, the second particular phrase 418, the phrases 422 and the electronic signature 420. The second email may comprise the second email-inherent data 1004 as depicted in FIG. 10. The second email-inherent data 1004 may comprise the second header data 1030 associated with the second header 450 and the second body data 1040 associated with the second body 460. The second email-inherent data 1004 may comprise the first attachment and the second attachment. It should be noted that the second email-inherent data 1004 may also comprise additional data and that the second email may comprise additional elements. In other words, the recipient's email address 404, the subject 406, the first attachment 408, the second attachment 410, the send button 414, the greeting 416, the second textual portion 444, the second particular phrase 418, the particular phrases 422 and the electronic signature 420 are examples of elements and are displayed, as depicted in FIG. 4, for ease of understanding only.

For example, the user 105 may enter the greeting 416, the second textual portion 444, the second particular phrase 418 via the user input interface of the second client device 103. The user 105 may also attach the first attachment and the second attachment. Further, the recipient's email address 404, the subject 406, the send button 414 and the particular phrases 422 may be generated automatically by the second email application 108 and displayed to the user 105 via the second email interface 110″ as it is known in the art. It should be noted that the second header data 1030 (see FIG. 10) may also comprise the information associated with the second email address since in this case the second email address is a sender's email address 702 of the second email (see FIG. 7).

In some embodiments of the present technology, the user 105 may select/interact with the send button 414. In this case, the second client device 103 may generate the fifth signal 170 (see FIG. 1) comprising inter alia the information associated with the second email-inherent data 1004 of the second email, wherein the second email-inherent data 1004 is structured according to the email-native protocol of the email service implemented by the server 116. The second client device 103 may send the fifth signal 170, via the communication network 114, to the server 116.

As previously alluded to, the server 116 may store the information received via the fifth signal 170 within the database 118. In other embodiments, the server 116 may be configured to send the information received via the fifth signal 170 to the first client device 102 for processing thereof. To that end, the server 116 may be configured to generate the sixth signal 190 comprising the information received via the fifth signal 170 and send the sixth signal 190 to the first client device 102.

In other embodiments, the sixth signal 190 may further comprise the first email-inherent data 1002 of the first email, wherein the first email-inherent data 1002 data is structured according to the email-native protocol of the email service implemented by the server 116. In additional embodiments, the sixth signal 190 may further comprise the second email-inherent data 1004 of the second email, wherein the second email-inherent data 1004 is structured according to the email-native protocol of the email service implemented by the server 116.

The first client device 102 may be configured to identify the second summary data 424 (see FIG. 5) within the second body data 1040 of the second email-inherent data 1004. In some embodiments, the first client device may extract the second summary data 424 from the second email-inherent data 1004.

For example, in order to extract the second summary data 424, the first client device 102 may be configured to extract the second header specific data 412 within the second email-inherent data 1004, the second body specific data 426 within the second email-inherent data 1004 and the second summary data 424 (see FIG. 4). The first client device 102 may extract the second header specific data 412 from the second email-inherent data 1004 by parsing the second header data 1030 of the second email-inherent data 1004. The first client device 102 may extract the second body specific data 426 by executing the regular expression analysis. For example, the first client device 102 may execute the regular expression analysis on the second body data 1040 of the second email-inherent data 1004.

The first client device 102 may extract the first summary data 210 from the first email-inherent data 1002 and the second summary data 424 from the second email-inherent data 1004 in a similar manner. In other words, the first client device 102 may extract the first textual portion 215 from the first email-inherent data 1002 and the second textual portion 444 from the second email-inherent data 1004 in a similar manner. The first client device 102 may extract the first header specific data 312 from the first email-inherent data 1002 and the second header specific data 412 from the second email-inherent data 1004 in a similar manner. The first client device 102 may extract the first body specific data 322 from the first email-inherent data 1002 and the second body specific data 426 from the second email-inherent data 1004 in a similar manner. Further, the first client device 102 may store the second header specific data 412 of the second email-inherent data 1004, the second body specific data 426 of the second email-inherent data 1004 and the second summary data 424 within the storage of the first client device 102.

In additional embodiment of the present technology, the first client device 102 may generate the second message element 516 depicted in FIG. 5. In other words, the first client device 102 may generate information for displaying the second message element 516. The second message element 516 may comprise the second summary data 424 extracted from the second email-inherent data 1004 depicted in FIG. 10. The second message element 516 may be associated with the second email. The first client device 102 may store the information associated with the second message element 516 within the storage of the first client device 102.

In some embodiments, the first client device 102 may be configured to trigger the display of the first message element 208 and the second message element 516 concurrently to the user 101 desirous to view the emails originated from and/or destined to the user 101 in the messenger-style display.

Another embodiment of the first email interface 106″ is depicted in FIG. 5. In this case, the first email interface 106″ may comprise the conversation title 202, the first message element 208 with the first summary data 210, the first user icon 212, the second user icon 514, the second message element 516 with the second summary data 424, the text field 204 and the send button 205.

In other embodiments, the first client device 102 may trigger the display of the first email and the second email in the messenger-style display as depicted in FIG. 5. In other words, the first email interface 106′ may display to the user 101 the messenger-style display of the first email and the second email within the first email application 104.

It should be noted that the first message element 208, as depicted in FIG. 5, may be visually distinguishable from the second message element 516. For example, the first user icon 212 and the second user icon 514 may allow the user 101 to visually distinguish the first message element 208 from the second message element 516 being displayed concurrently. As another example, a visual element 518 may allow the user 101 to visually distinguish the first message element 208 form the second message element 516. Also, the second message element 516 may have a different color, font, size and/or positioning from the first message element 208 for allowing the user 101 to visually distinguish the first message element 208 form the second message element 516 being displayed concurrently.

In alternative embodiments of the present technology, an attachment element 520 may be displayed as part of the second message element 516. The attachment element 520 may indicate the user 101 that the second message element 516 is associated with the second email which comprises at least one attachment (e.g., the first attachment and the second attachment).

In some embodiments of the present technology, the first message element 208 and the second message element 516 displayed to the user 101 by the first email interface 106″ depicted in FIG. 5 may be the first interactive message element and the second interactive message element, respectively.

In alternative embodiments, upon the user 101 interacting with the first interactive message element, the first client device 102 may be configured to trigger the display of the first email associated with the first interactive message element without sending the indication of the interaction with the first interactive message element to the server 116.

For example, an additional embodiment of the first email interface 106′″ is depicted in FIG. 6. In this case, the first email interface 106′″ may display the first email associated with the first interactive message element following the triggering of the display by the first client device 102.

In some embodiments, upon the user 101 interacting with the second interactive message element, the first client device 102 may send the indication (not depicted) of the interaction with the second interactive message element to the server 116. In response, the server 116 may be configured to trigger the display of the second email associated with the second interactive message element. In other embodiments, the first client device 102 may be configured to trigger the display of the second email associated with the second interactive message element without sending the indication of the interaction with the second interactive message element to the server 116.

For example, an additional embodiment of the first email interface 106″″ is depicted in FIG. 7. In this case, the first email interface 106″″ may display the second email associated with the second interactive message element following the triggering of the display by the first client device 102. It should be noted, that the user 101 may open the first attachment and/or the second attachment by interacting with the first attachment indication 408 and/or the second attachment indication 410, respectively, within the first email interface 106″″.

In some embodiments of the present technology, an electronic device may be implemented for executing a method 800 of processing emails. The method 800 will be further described below.

STEP 802: Retrieving the First and the Second Email

The method 800 begins at step 802 with the electronic device retrieving the first email originated from the user 101 of the email service and the second email destined to the user 101 of the email service, the first email and the second email comprising the respective first email-inherent data 1002 and the second email-inherent data 1004, wherein the first email-inherent data 1002 and the second email-inherent data 1004 is structured according to the email-native protocol of the email service.

For example, the first email-inherent data 1002 and the second email-inherent data 1004 may be structured according to Simple Mail Transfer Protocol. However, the first email-inherent data 1002 and the second email-inherent data 1004 may be structured according to the any other email-native protocol.

In other embodiments, the electronic device may be the server 116 hosting the email service as depicted in FIG. 1. In this case, the server 116 may store the first email-inherent data 1002 of the first email within the database 118. The server 116 may receive the second email-inherent data 1004 of the second email from the second client device 103 via the fifth signal 170 comprising inter alia the information associated with the second email-inherent data 1004. As a result, the server 116 may retrieve the first email and the second email from the database 118.

In some embodiments, the electronic device may be the first client device 102 associated with the user 101 as depicted in FIG. 1. In this case, the first client device 102 may store the first email-inherent data 1002 of the first email within the storage (not depicted) thereof. In other embodiments, the first client device 102 may retrieve the first email-inherent data 1002 and the second email-inherent data 1004 from the server 116 by receiving the sixth signal 190 comprising inter alia the first email-inherent data 1002 of the first email and the second email-inherent data 1004 of the second email.

STEP 804: Identifying the First and the Second Summary Data

The method 800 continues to step 804 with the electronic device identifying the first summary data 210 of the first email and the second summary data 424 of the second email. The electronic device identifying the first summary data 210 and the second summary data 424 may comprise extracting the first summary data 210 and the second summary data 424 from the respective first email-inherent data 1002 and the second email-inherent data 1004 based on the email-native protocol.

In some embodiments, the electronic device may be the server 116 hosting the email service as depicted in FIG. 1. In this case, the server 116 may identify the first summary data 210 from the information associated with the first textual portion 215.

In other embodiments, the server 116 may identify the first summary data 210 and the second summary data 424 within the first email-inherent data 1002 and the second email-inherent data 1004 respectively. More precisely, the server 116 may extract the first summary data 210 from the first body data 1020 of the first email-inherent data 1002 and the second summary data 424 from the second body data 1040 of the second email-inherent data 1004. In order to extract the first summary data 210, the server 116 may extract the first textual portion 215, the first header specific data 312 and the first body specific data 322 from the first email-inherent data 1002 being structured according to the email-native protocol. In order to extract the second summary data 424, the server 116 may extract the second textual portion 444, the second header specific data 412 and the second body specific data 426 from the second email-inherent data 1004 being structured according to the email-native protocol. The server 116 may further store within the database 118 the first summary data 210 and the second summary data 424.

In additional embodiments, the electronic device may extract the first body specific data 322 from the first email-inherent data 1002 and the second body specific data 426 from the second email-inherent data 1004 by executing the regular expression analysis. For example, the electronic device may execute the regular expression analysis on the first body data 1020 and the second body data 1040 to extract the first summary data 210 and the second summary data 424, respectively.

In some embodiments, the electronic device may be the first client device 102 associated with the user 101 as depicted in FIG. 1. In this case, the first client device 102 may identify the first summary data 210 by extracting the first summary data 210 from the first email-inherent data 1002 stored within the storage thereof.

In other embodiments, the first client device 102 may identify the first summary data 210 and the second summary data 424 within the first email-inherent data 1002 and the second email-inherent data 1004 respectively. More precisely, the first client device 102 may extract the first summary data 210 from the first body data 1020 of the first email-inherent data 1002 and the second summary data 424 from the second body data 1040 of the second email-inherent data 1004. In order to extract the first summary data 210, the first client device 102 may extract the first textual portion 215, the first header specific data 312 and the first body specific data 322 from the first email-inherent data 1002. In order to extract the second summary data 424, the first client device 102 may extract the second textual portion 444, the second header specific data 412 and the second body specific data 426 from the second email-inherent data 1004.

STEP 806: Generating the First and the Second Message Element

The method 800 continues to step 806 with the electronic device generating the first message element 208 and the second message element 516, wherein the first message element 208 and the second message element 516 are associated with the first and the second email respectively. The first message element 208 may comprise the first summary data 210 and the second message element 516 may comprise the second summary data 424.

In some embodiments, the electronic device may be the server 116 hosting the email service as depicted in FIG. 1. In this case, the server 116 may generate the first message element 208 and the second message element 516, wherein the first message element 208 and the second message element 516 are associated with the first and the second email respectively. In other words, the server 116 may generate the information for triggering the display of the first message element 208 and the second message element 516.

In other embodiments, the electronic device may be the first client device 102 associated with the user 101 as depicted in FIG. 1. In this case, the first client device 102 may generate the first message element 208 and the second message element 516, wherein the first message element 208 and the second message element 516 are associated with the first and the second email respectively.

STEP 808: Triggering the Display of the First and the Second Massage Element

The method 800 ends at step 808 with the electronic device triggering the display of the first message element 208 and the second message element 516 concurrently, wherein the first message element 208 is visually distinguishable from the second message element 516.

In some embodiments, the electronic device may be the server 116 hosting the email service as depicted in FIG. 1. In this case, the server 116 may trigger the display of the first message element 208 and the second message element 516 concurrently within the first email interface 106″ as depicted in FIG. 5. In an additional embodiment, the server 116 may send a trigger (not depicted) for causing a screen of the first client device 102 to display the first message element 208 and the second message element 516 concurrently.

In other embodiments, the electronic device may be the first client device 102 associated with the user 101 as depicted in FIG. 1. In this case, the first client device 102 may trigger the display of the first message element 208 and the second message element 516 concurrently within the first email interface 106″ as depicted in FIG. 5. For example, the first client device 102 may cause the screen thereof to display the first message element 208 and the second message element 516 concurrently within the first email interface 106″ of the first email application 104.

In additional embodiments, the first message element 208 and the second message element 516 may be the first and the second interactive message element, respectively. For example, upon the user 101 interacting with the first interactive message element 208, the electronic device may trigger the display of the first email associated with the first interactive message element.

In the case where the electronic device is the server 116, the first client device 102 may send the indication of the interaction with the first interactive message element to the server 116. In response, the server 116 may retrieve from the database 118 the first email-inherent data 1002 and trigger the display of the first email associated with the first interactive message element. In the case where the electronic device is first client device 102, the first client device 102 may retrieve the first email-inherent data 1002 from the storage thereof and trigger the display of the first email associated with the first interactive message element.

In the case where the electronic device is the server 116, the first client device 102 may send the indication of the interaction with the second interactive message element to the server 116. In response, the server 116 may retrieve from the database 118 the second email-inherent data 1004 and trigger the display of the second email associated with the second interactive message element. In the case where the electronic device is first client device 102, the first client device 102 may retrieve the second email-inherent data 1004 from the storage thereof and trigger the display of the second email associated with the second interactive message element.

In some embodiments of the present technology, the system 100, which comprises the server 116, the communication network 114 and the first client device 102, may be implemented for executing a method 900 of processing emails. The method 900 will be further described below.

STEP 902: Retrieving a First and a Second Email by the Server

The method 900 begins at step 902 with the server 116 retrieving the first email originated from the user 101 of the email service and the second email destined to the user 101 of the email service, the first email and the second email comprising the respective first email-inherent data 1002 and the second email-inherent data 1004, wherein the first email-inherent data 1002 and the second email-inherent data 1004 is structured according to the email-native protocol of the email service.

STEP 904: Identifying a First and a Second Summary Data by the Server

The method 900 continues to step 904 with the server 116 identifying the first summary data 210 of the first email and the second summary data 424 of the second email. The server 116 identifying the first summary data 210 and the second summary data 424 may comprise extracting the first summary data 210 and the second summary data 424 from the respective first email-inherent data 1002 and the second email-inherent data 1004 based on the email-native protocol.

STEP 906: Sending a Signal by the Server to the Client Device Via the Communication Network

The method 900 continues to step 906 with the server 116 sending to the first client device 102 via the communication network 114, the sixth signal 190 comprising inter alia the information associated with the first summary data 210 and the second summary data 424.

STEP 908: Generating a First and a Second Message Element by the Client Device

The method 900 continues to step 908 with the first client device 102 generating the first message element 208 and the second message element 516, wherein the first message element 208 and the second message element 516 are associated with the first and the second email respectively. The first message element 208 may comprise the first summary data 210 and the second message element 516 may comprise the second summary data 424.

In some embodiments, prior to the step 906, the method 900 may comprise generating, by the server 116, the first message element 208 and the second message element 516. In this case, the method 900 may further comprise the server 116 sending the sixth signal 190 further comprising the information associated with the first message element 208 and the second message element 516 to the first client device 102. The sixth signal 190 may comprise the information for triggering the display of the first message element 208 and the second message element 516.

STEP 910: Triggering a Display of a First and Second Message Element by the Client Device

The method 900 ends at step 910 with the first client device 102 triggering the display of the first message element 208 and the second message element 516 concurrently, wherein the first message element 208 is visually distinguishable from the second message element 516.

It should be noted that in some implementations of the present technology, the electronic device executing the method 800 and/or the system 100 executing the method 900 may allow the user 101 to view the emails originated from and/or destined to the user 101 in the messenger-style display. The messenger-style display of the emails originated from and/or destined to the user 101 may allow the user 101 to quickly view a summary of a communication history with another user, such as the user 105 for example, without viewing redundant information which is usually comprised within the emails. This in turn may allow presenting more information to the user 101 within a relatively limited real estate of a display, which is the case, for example, when the user 101 is using a smartphone, as an example.

Further, the electronic device executing the method 800 and/or the system 100 executing the method 900 may furnish a hybrid form of communication (between emails and instant messaging) that has a positive effect on user experience of the user 101 during information exchange with the user 105, for example. The method 800 and/or the method 900 may allow reconciliation different communicational platforms for providing advantages of email communication and instant message communication to the user 101.

Within the present description it should be understood that in all places where indicated the receiving data from any electronic device and/or from any email server and/or from any other server, the receiving of electronic or any other signal from suitable electronic device (server, email server) can be used, and the displaying on the device screen can be implemented as the transmission the signal to the display comprising certain information which further can be interpreted in a certain way and at least partially displayed on the screen of the electronic device. Transmitting and receiving of the signal are not mentioned everywhere within present description to simplify the description and for a better understanding of present solution. Signals can be transmitted by optical methods (for example, via fiber-optic connection), by electronic methods (via wired or wireless connection), by mechanical methods (transmitting of the pressure, temperature and/or other physical parameters by means of which the transmission of the signal is possible).

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

As such, from one perspective, embodiments of the present technology described above can be summarized as follows, structured in numbered clauses.

CLAUSE 1. A method (800) of processing emails, the method (800) being executed by an electronic device, the method (800) comprising:
retrieving (802), by the electronic device, a first email originated from a user (101) of an email service and a second email destined to the user (101) of the email service, the first email and the second email comprising a respective first and a second email-inherent data, the first and the second email-inherent data being structured according to an email-native protocol of the email service;
identifying (804), by the electronic device, a first summary data (210) of the first email and a second summary data (424) of the second email, the identifying (804) the first (210) and the second summary data (424) comprises extracting, by the electronic device, the first (210) and second summary data (424) from the respective first and the second email-inherent data based on the email-native protocol;
generating (806), by the electronic device, a first (208) and a second message element (516), the first (208) and the second message element (516) being associated with the first and the second email respectively, the first message element (208) comprising the first summary data (210) and the second message element (516) comprising the second summary data (424); and
triggering (810), by the electronic device, a display of the first (208) and the second message element (516) concurrently, the first message element (208) being visually distinguishable from the second message element (516).

CLAUSE 2. The method of clause 1, wherein the electronic device is a server (116) hosting the email service.

CLAUSE 3. The method of clause 1, wherein the electronic device is a client device (102) associated with the user (101).

CLAUSE 4. The method of clause 1, wherein the email-native protocol is Simple Mail Transfer Protocol.

CLAUSE 5. The method of clause 1, wherein the extracting the first (210) and the second summary data (424) comprises extracting, by the electronic device, from the first and the second email-inherent data:
a first (215) and a second textual portion (444), respectively;
a first (312) and a second header specific data (412), respectively; and
a first (322) and a second body specific data (426), respectively.

CLAUSE 6. The method of clause 5, wherein each of the first (312) and the second header specific data (412) comprises at least one of:
a subject (308, 406);
a sender's email address (304, 702);
a recipient's email address (306, 404); and
attachments.

CLAUSE 7. The method of clause 5, wherein each of the first (322) and the second body specific data (426) comprises at least one of:
an electronic signature (318, 420);
a greeting (314, 416); and
particular phrases (316, 418, 422).

CLAUSE 8. The method of clause 5, wherein the extracting the first (322) and the second body specific data (426) is executed via a regular expression analysis.

CLAUSE 9. The method of clause 5, wherein the extracting the first (312) and the second header specific data (412) is executed via parsing.

CLAUSE 10. The method of clause 1, wherein the first (208) and the second message element (516) are a first and a second interactive message element, respectively.

CLAUSE 11. The method of clause 10, upon the user (101) interacting with the first interactive message element, the method (800) further comprises triggering, by the electronic device, a display of the first email associated with the first interactive message element.

CLAUSE 12. The method of clause 10, upon the user (101) interacting with the second interactive message element, the method (800) further comprises triggering, by the electronic device, a display the second email associated with the second interactive message element.

CLAUSE 13. A method (900) of processing emails, the method (900) executed in a system (100), the system (100) including:
a communication network (114);
a server (116) hosting an email service, the server (116) being connected to the communication network (114); and
a client device (102) associated with a user (101) of the email service, the client device (102) being connected to the communication network (114);
   the method (900) comprising:
retrieving (902), by the server (116), a first email originated from the user (101) of the email service and a second email destined to the user (101) of the email service, the first email and the second email comprising a respective first and a second email-inherent data, the first and the second email-inherent data being structured according to an email-native protocol of the email service;
identifying (904), by the server (116), a first summary data (210) of the first email and a second summary data (424) of the second email, the identifying (904) the first (210) and the second summary data (424) comprises extracting, by the server (116), the first (210) and second summary data (424) from the respective first and the second email-inherent data based on the email-native protocol;
sending (906), by the server (116) to the client device (102) via the communication network (114), a signal (190) comprising information associated with the first (210) and the second summary data (424);
generating (908), by the client device (102), a first (208) and a second message element (526), the first (208) and the second message element (516) being associated with the first and the second email respectively, the first message element (208) comprising the first summary data (210) and the second message element (516) comprising the second summary data (424); and
triggering (910), by the client device (102), a display of the first (208) and the second message element (516) concurrently, the first message element (208) being visually distinguishable from the second message element (516).

CLAUSE 14. The method of clause 13, wherein prior to the sending (906) the signal (190) the method (900) comprises generating, by the server (116), information for triggering the display of the first (208) and the second message element (516), the first (208) and the second message element (516) being associated with the first and the second email respectively, the first message element (208) comprising the first summary data (210) and the second message element (516) comprising the second summary data (424); and wherein the method (900) further comprises:
sending, by the server (116) to the client device (102) via the communication network (114), the signal (190) comprising information for triggering the display of the first (208) and the second message element (516); and
triggering, by the client device (102), the display of the first (208) and the second message element (516) concurrently, the first message element (208) being visually distinguishable from the second message element (516).

CLAUSE 15. A server (116) for processing emails, the server (116) being configured to execute a method (800) of clauses 1 to 12.

CLAUSE 16. A client device (102) for processing emails, the client device (102) being configured to execute a method (800) of clauses 1 to 12.

What is claimed is:

1. A method of processing emails, the method being executed by an electronic device, the method comprising:
retrieving, by the electronic device, a first email originated from a user of an email service and a second email destined to the user of the email service, the first email and the second email comprising a respective first and a second email-inherent data, the first and the second email-inherent data being structured according to an email-native protocol of the email service;
identifying, by the electronic device, a first summary data of the first email and a second summary data of the second email, the identifying the first and the second summary data comprises extracting, by the electronic device, the first and second summary data from the respective first and the second email-inherent data based on the email-native protocol;
generating, by the electronic device, a first and a second message element, the first and the second message element being associated with the first and the second email respectively, the first message element comprising the first summary data and the second message element comprising the second summary data; and
triggering, by the electronic device, a display of the first and the second message element concurrently, the first message element being visually distinguishable from the second message element.

2. The method of claim 1, wherein the electronic device is a server hosting the email service.

3. The method of claim 1, wherein the triggering comprises transmitting, to a client device associated with the user, a trigger for causing a screen of the client device to display the first and the second message element concurrently.

4. The method of claim 1, wherein the electronic device is a client device associated with the user.

5. The method of claim 1, wherein the triggering comprises causing a screen of the client device to display the first and the second message element concurrently.

6. The method of claim 1, wherein the email-native protocol is Simple Mail Transfer Protocol.

7. The method of claim 1, wherein the extracting the first and the second summary data comprises extracting, by the electronic device, from the first and the second email-inherent data:
a first and a second textual portion, respectively;
a first and a second header specific data, respectively; and
a first and a second body specific data, respectively.

8. The method of claim 7, wherein each of the first and the second header specific data comprises at least one of:
a subject;
a sender's email address;
a recipient's email address; and
attachments.

9. The method of claim 7, wherein each of the first and the second body specific data comprises at least one of:
an electronic signature;
a greeting; and
particular phrases.

10. The method of claim 7, wherein the extracting the first and the second body specific data is executed via a regular expression analysis.

11. The method of claim 7, wherein the extracting the first and the second header specific data is executed via parsing.

12. The method of claim 1, wherein the first and the second message element are a first and a second interactive message element, respectively.

13. The method of claim 12, upon the user interacting with the first interactive message element, the method further comprises triggering, by the electronic device, a display of the first email associated with the first interactive message element.

14. The method of claim 12, upon the user interacting with the second interactive message element, the method further comprises triggering, by the electronic device, a display the second email associated with the second interactive message element.

15. A method of processing emails, the method executed in a system, the system including:
a communication network;
a server hosting an email service, the server being connected to the communication network; and
a client device associated with a user of the email service, the client device being connected to the communication network;
the method comprising:
retrieving, by the server, a first email originated from the user of the email service and a second email destined to the user of the email service, the first email and the second email comprising a respective first and a second email-inherent data, the first and the second email-inherent data being structured according to an email-native protocol of the email service;
identifying, by the server, a first summary data of the first email and a second summary data of the second email, the identifying the first and the second summary data comprises extracting, by the server, the first and second summary data from the respective first and the second email-inherent data based on the email-native protocol;
sending, by the server to the client device via the communication network, a signal comprising information associated with the first and the second summary data;
generating, by the client device, a first and a second message element, the first and the second message element being associated with the first and the second email respectively, the first message element comprising the first summary data and the second message element comprising the second summary data; and
triggering, by the client device, a display of the first and the second message element concurrently, the first message element being visually distinguishable from the second message element.

16. The method of claim 15, wherein prior to the sending the signal the method comprises generating, by the server, information for triggering the display of the first and the second message element, the first and the second message element being associated with the first and the second email respectively, the first message element comprising the first summary data and the second message element comprising the second summary data; and wherein the method further comprises:
sending, by the server to the client device via the communication network, the signal comprising the information for triggering the display of the first and the second message element; and
triggering, by the client device, the display of the first and the second message element concurrently, the first message element being visually distinguishable from the second message element.

17. A server for processing emails, the server being configured to:
retrieve a first email originated from a user of an email service and a second email destined to the user of the email service, the first email and the second email comprising a respective first and a second email-inherent data, the first and the second email-inherent data being structured according to an email-native protocol of the email service;
identify a first summary data of the first email and a second summary data of the second email, to identify the first and the second summary data comprises to extract the first and second summary data from the respective first and the second email-inherent data based on the email-native protocol;
generate a first and a second message element, the first and the second message element being associated with the first and the second email respectively, the first message element comprising the first summary data and the second message element comprising the second summary data; and
trigger a display of the first and the second message element concurrently, the first message element being visually distinguishable from the second message element.

18. A client device for processing emails, the client device being configured to:
retrieve a first email originated from a user of an email service and a second email destined to the user of the email service, the first email and the second email comprising a respective first and a second email-inherent data, the first and the second email-inherent data being structured according to an email-native protocol of the email service;
identify a first summary data of the first email and a second summary data of the second email, to identify the first and the second summary data comprises to extract the first and second summary data from the respective first and the second email-inherent data based on the email-native protocol;
generate a first and a second message element, the first and the second message element being associated with the first and the second email respectively, the first message element comprising the first summary data and the second message element comprising the second summary data; and
trigger a display of the first and the second message element concurrently, the first message element being visually distinguishable from the second message element.
